(19) United States
(12) Patent Application Publication
(10) Pub. No.: US 2019/0077697 A1
(43) Pub. Date: Mar. 14, 2019

(54) LOW-DISPERSION OXYFLUORIDE GLASS

(71) Applicant: Shanghai Xinhe Photoelectric Technology Co., Ltd., Shanghai (CN)

(72) Inventor: Xinqiang Yuan, Shanghai (CN)

(21) Appl. No.: 16/071,902

(22) PCT Filed: Mar. 2, 2016
(86) PCT No.: PCT/CN2016/075351

§ 371 Date: Jul. 20, 2018

(30) Foreign Application Priority Data
Jan. 21, 2016 (CN) 201610040341.0

(51) Int. Cl. C03C 3/247; C03C 3/12; C03C 4/20

(52) U.S. Cl. CPC C03C 3/247; C03C 2203/10; C03C 4/20; C03C 3/125

(57) ABSTRACT

A low dispersion oxyfluoride glass comprising: in terms of cationic molar percentage: Al³⁺: 18 to 50, Y³⁺: 10 to 18, Mg²⁺: 5 to 12, Ca²⁺: 15 to 25, Sr²⁺: 5 to 15, Ba²⁺: 5 to 12, P⁵⁺: 0 to 0.1, La³⁺: 0 to 6, Li⁺: 0 to 5, Na⁺: 0 to 5, and K⁺: 0 to 5; and in terms of anionic molar percentage: F⁻: 97 to 99.98, O²⁻: 0.02 to 3, and Cl⁻: 0 to 1. The oxyfluoride glass has an ultra-low dispersion property as well as excellent chemical stability and mechanical processing performance.

### FIELD OF THE INVENTION

The present invention relates to an ultra-low dispersion oxyfluoride optical glass, and particularly to an optical lens material suitable for precision press molding having a low refractive index and a high Abbe number.

### BACKGROUND OF THE INVENTION

Because a low dispersion lens can effectively reduce the color difference in imaging, and an aspherical manufacturing process makes it possible to effectively eliminate the impact of the spherical aberration, optical glass materials having low dispersion performance and meeting the precision press molding (low-cost production of aspherical lenses) have become one of the preferred materials for various high-definition lenses (HD lenses).

Currently, fluorophosphate glass compositions are commonly employed to prepare such ultra-low-dispersion optical materials in the industry (such as China Patent Application Nos. 201210280051.5, 201210371431.X; Japanese Patent Laid-Open Nos. 2014-005202, 2009-203114, and U.S. Pat. Nos. 4,808,556, 8,642,490B2). In addition to fluoride as the main content, the composition further comprises a certain amount of phosphate or phosphorus pentoxide, the molar content of phosphorus (relative to cations) being greater than 2%. However, during the production process of fluorophosphate glass, due to the presence of a large amount of phosphorus, significant volatilization is caused. Thus, on the one hand, volatilization striations (even crystallization and generation of stones) are liable to occur during the glass molding process, decreasing the yield rate, but on the other hand, a harmful white smoke formed from the combination of phosphorus and fluorine has an adverse effect on equipment and operators, and also increases the cost of waste gas treatment. In addition, the Abbe number (indicating dispersion performance index) of the fluorophosphate glass described in the above-mentioned patents is generally less than 99. In the pursuit of lower dispersion and higher performance in optical design, optical glass with a higher Abbe number is highly demanded. Chinese Patent Application No. 200710162812.6 discloses an optical glass in which the elemental mass % of phosphorus can be reduced to 0.1%, but phosphorus is still an essential element of the material, and the Abbe number of this optical glass is still difficult to reach 99 or more.

### SUMMARY OF THE INVENTION

To address the above issues, an object of the present invention is to provide an oxyfluoride glass that has low dispersion performance, is suitable for precision press molding, and is environmentally friendly.

Herein, provided is a low dispersion oxyfluoride glass, comprising:

in terms of cationic molar percentage: Al³⁺: 18 to 50, Y³⁺: 10 to 18, Mg²⁺: 5 to 12, Ca²+: 15 to 25, Sr²⁺: 5 to 15, Ba²⁺: 5 to 12, P⁵⁺: 0 to 0.1, La³⁺: 0 to 6, Li⁺: 0 to 5, Na⁺: 0 to 5, and K⁺: 0 to 5; and

in terms of anionic molar percentage: F⁻: 97 to 99.98, O²⁻: 0.02 to 3, and Cl⁻: 0 to 1.

The oxyfluoride glass of the present invention has ultra-low dispersion performance and has an Abbe number of 99 to 102. In addition, the oxyfluoride glass of the present invention does not comprise phosphorus or comprises only a very small amount of phosphorus (less than 0.1%, cationic molar percentage), which can avoid volatilization of P, thereby increasing the yield, avoiding the impact of the harmful white smoke formed by a combination of phosphorus and fluorine on equipment and operators, and reducing the cost of waste gas treatment.

Preferably, the glass comprises:

in terms of cationic molar percentage: Al³⁺: 30 to 40, Y³⁺: 12 to 16, Mg²⁺: 7 to 11, Ca²⁺: 18 to 22, Sr²⁺: 8 to 12, Ba²⁺: 8 to 10, P⁵⁺: 0 to 0.1, La³⁺: 0 to 3, Li⁺: 0 to 3, Na⁺: 0 to 3, and K⁺: 0 to 3; and

in terms of cationic molar percentage: F⁻: 99 to 99.5, O²⁻: 0.05 to 1, and Cl⁻: 0 to 0.5.

More preferably, the glass does not comprise P⁵⁺.

The oxyfluoride glass of the present invention also has a low refractive index, and its refractive index may be 1.41 to 1.44.

The oxyfluoride glass of the present invention has a transition temperature of less than 460° C. and is suitable for precision press molding to produce an aspherical optical lens.

In the present invention, F⁻ may be introduced by employing fluorides of the cations in the composition as starting materials.

In the present invention, Cl⁻ may be introduced by employing chlorides of the cations in the composition as starting materials.

In the present invention, O²⁻ may be introduced by employing oxides of the cations in the composition as starting materials.

O²⁻ may also be introduced by the following process: during the high-temperature reaction melting of the glass melt, the glass melt is protected by an atmosphere containing oxygen element to introduce O²⁻, or an atmosphere containing oxygen element is fed into the glass melt, so that the atmosphere containing oxygen element reacts with the fluoride ingredient to introduce O²⁻. The atmosphere containing oxygen element is preferably at least one of air, oxygen, and water vapor.

The present invention further provides an optical element made of any of the above-mentioned low-dispersion oxyfluoride glasses.

According to the present invention, an oxyfluoride glass having ultra-low dispersion performance, excellent chemical stability, and mechanical processing performance can be provided, which is suitable for preparation of optical elements such as high-performance spherical, aspherical, and planar lenses, prisms, and gratings by precision press molding, secondary hot pressing, and cold working methods.

### BRIEF DESCRIPTION OF THE DRAWINGS

FIG. 1 is Table 1 showing the composition (mol %) of Examples 1-10.

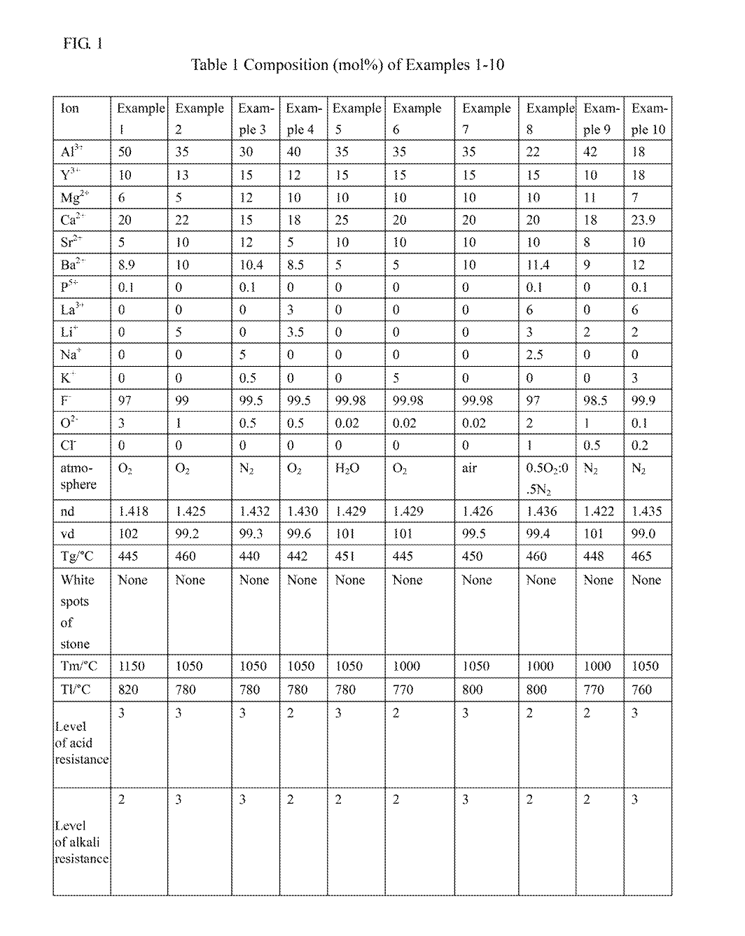

FIG. 2 is Table 2 showing the composition (mol %) of Comparative Examples 1-10.

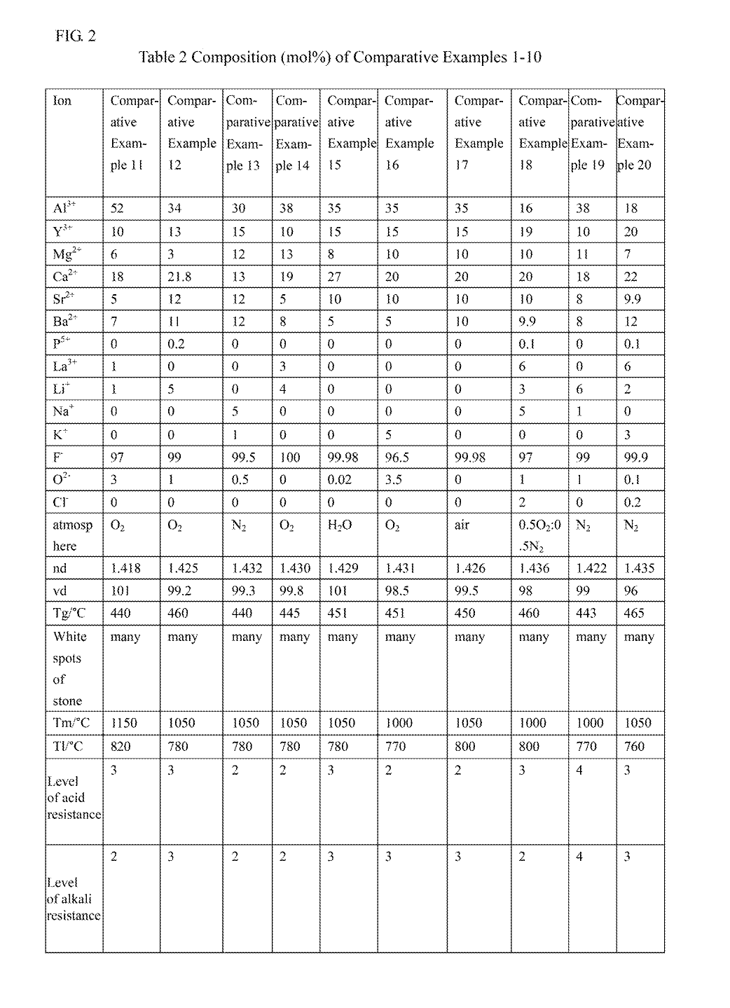

### DETAILED DESCRIPTION OF THE EMBODIMENTS

The present invention will be further described with the following embodiments. It should be understood that the following embodiments are only used for explaining this invention, and do not limit this invention.

The present invention provides an oxyfluoride glass composition which has excellent glass forming properties, and is suitable for producing high quality, low dispersion optical glass, and is suitable for precision press molding. The invention solves two problems at the same time: 1. An optical glass composition with ultra-low dispersion performance is provided, whose Abbe number reaches 99 to 102; 2. A low dispersion optical oxyfluoride glass composition which does not comprise phosphorus, or only comprises a very small amount of phosphorus (less than 0.1% or even 0%, in terms of cationic molar percentage) is provided.

In this specification, unless otherwise specified, the cationic molar percentage is expressed by the molar percentage of the cation in the total cations, and the anionic molar percentage is expressed by the molar percentage of the anion in the total anions. In addition, 0% of a certain ingredient X means that the content of the ingredient X is 0%, that is, it means that the ingredient X is not contained.

In addition, it should be noted that in the present specification, for the sake of convenience, the ionic valencies of the respective ingredients use the representative valencies and are not distinguished from other ionic valencies. The ionic valency of each ingredient present in the optical glass may be an ionic valency other than the representative valency. For example, P is usually present in glass in a valency state of 5 and is therefore referred to as “P⁵⁺” in this specification. However, P may also be present in other valency states. Strictly speaking, each ingredient also exists in the state of other ionic valencies, but in the present specification, each ingredient is regarded as existing in the optical glass in the representative ionic valency.

The glass of the present invention comprises cationic ingredients and anionic ingredients. The glass of the present invention comprises (by molar content):

in terms of cationic percentage (percentage of cation in total cations)

Al³⁺: 18%˜50%

Y³⁺: 10%˜18%

Mg²⁺: 5%˜12%

Ca²⁺: 15%˜25%

Sr²⁺: 5%˜15%

Ba²⁺: 5%˜12%

P⁵⁺: 0˜0.1%

La³⁺: 0˜6%

Li⁺: 0˜5%

Na⁺: 0˜5%

K⁺: 0˜5%,

the sum of the percentages of the above cations being preferably 100%;

in terms of anionic percentage (percentage of anion in total anions)

F⁻: 97%˜99.98%

O²⁻: 0.02%˜3%

Cl⁻: 0˜1%,

the sum of the percentages of the above anions being preferably 100%.

In the present invention, the content of P⁵⁺ is less than 0.1%, and P⁵⁺ may not even be contained at all, and therefore volatile POFₓ compounds will rarely be formed at a high temperature, which significantly reduces the volatilization of harmful gases during high-temperature preparation and is advantageous for consistent control of glass performance.

Since there is almost no volatilization during the precision press molding, there is no obvious corrosion to the press mold material, and the service life of the press mold material can be prolonged.

Since the composition of the present invention comprises no or only a small amount of P⁵⁺, there is no corrosion or only slight corrosion to the platinum crucible during the high-temperature melting process, and the service life of the production line can be significantly improved.

Hereinafter, each ingredient of the optical glass of this invention is described in detail.

Al³⁺ is a basic and essential ingredient of the composition of the present invention, and acts as a network former in the glass structure. The content of Al³⁺ is 18% to 50%. If it is less than 18%, the stability of the glass decreases, the dispersion of the glass increases, and the Abbe number is less than 99; if it is greater than 50%, the stability of the glass decreases, a high optical quality sample cannot be obtained, and the glass transition temperature may increase, making the precision press molding more difficult. The content of Al³⁺ is more preferably 30% to 40%.

Al³⁺ can be introduced by using its fluoride and/or partial oxide such as AlF₃, Al₂O₃, or the like as a raw material.

Y³⁺ is an essential ingredient and also acts as a network former in glass. If the content of Y³⁺ is less than 10%, the stability of the glass deteriorates, and if the content of Y³⁺ is more than 18%, the stability of the glass decreases, and the Abbe number may be less than 99. The content of Y³⁺ is more preferably 12% to 16%.

Y³⁺ can be introduced by using its fluoride and/or partial oxide such as YF₃, Y₂O₃, or the like as a raw material.

Mg²⁺ is an essential ingredient, and acts as a network modifier in the glass structure, improving the stability of the glass. If the content of Mg²⁺ is less than 5% or greater than 12%, the stability of the glass decreases, and a small white spot of stone may appear inside the glass during glass casting. The more preferred Mg²⁺ content is 7% to 11%.

Mg²⁺ can be introduced by using its fluoride and/or partial oxide such as MgF₂, MgO, or the like as a raw material.

Ca²⁺ is an essential ingredient, and acts as a network modifier in the glass structure, improving the stability of the glass. If the content of Ca²⁺ is less than 15% or greater than 25%, the stability of the glass decreases, and a small white spot of stone may appear inside the glass during glass casting. The more preferred Ca²⁺ content is 18% to 22%.

Ca²⁺ can be introduced by using its fluoride and/or partial oxide such as CaF₂, CaO, or the like as a raw material.

Sr²⁺ is an essential ingredient, and acts as a network modifier in the glass structure, improving the stability of the glass. If the content of Sr²⁺ is less than 5% or greater than 15%, the stability of the glass decreases, and a small white spot of stone may appear inside the glass during glass casting. The more preferred Sr²⁺ content is 8% to 12%.

Sr²⁺ can be introduced by using its fluoride and/or partial oxide such as SrF₂, SrO, or the like as a raw material.

Ba²⁺ is an essential ingredient, and acts as a network modifier in the glass structure, improving the stability of the glass. If the content of Ba²⁺ is less than 5% or greater than 12%, the stability of the glass decreases, and a small white spot of stone may appear inside the glass during glass casting. The more preferred Ba²⁺ content is 8% to 10%.

Ba²⁺ can be introduced by using its fluoride and/or partial oxide such as BaF₂, BaO, or the like as a raw material.

Major anions in the glass are F⁻ ions. If the content of F⁻ is less than 97% of the total anions, the dispersion performance of the glass decreases, and the Abbe number may be lower than 99. If the content of F⁻ is greater than 99.98%, the stability of the glass deteriorates, the casted glass melt may be completely opaque, or stones may be generated inside the glass. The more preferred content of fluorine ion is 99% to 99.5%.

F⁻ may be introduced by using fluorides of the cations in the composition as starting materials.

O²⁻ is one of the main anions in the glass provided by the present invention and is an essential ingredient. If the content of O²⁻ is less than 0.02%, the stability of the glass is poor, and the whole glass may be milky white during molding, or a severe flash point of the stone may occur in the glass, and thus a high optical quality glass cannot be obtained. If the content of oxygen is greater than 3%, the dispersion of the glass increases, and the Abbe number may be less than 99. The oxygen ions may be introduced into the glass in the form of oxides of the cations in the composition, or by reacting the glass melt with an atmosphere containing oxygen element (for example, one or more of oxygen, air, water vapor, etc.) to produce oxides during the high-temperature melting process of the glass. The atmosphere may be a protective atmosphere for glass melt during high-temperature melting of the glass, or fed directly into the glass melt. The more preferred content of oxygen ion is 0.05% to 1%.

Cl⁻ is an ion that increases the stability of the glass, but not an essential ingredient. The content of Cl⁻ is 0 to 1%. If the content is more than 1%, the dispersion of glass may increase and the Abbe number may be less than 99. The more preferred content is 0 to 0.5%.

Cl⁻ may be introduced by using chlorides of the cations in the composition as starting materials.

P⁵⁺ is an ingredient that improves the stability of the glass, but not an essential ingredient. In the present invention, the P⁵⁺ content may be 0 to 0.1%. If the P⁵⁺ content is greater than 0.1%, P volatilizes and a large amount of volatile POFₓ compounds is generated, and in addition, the glass dispersion may be increased and the Abbe number may be lower than 99. The preferred P⁵⁺ content is 0 to 0.05%. From the standpoint of improving dispersion and environmental friendliness, the smaller the P⁵⁺ content, the better. The P⁵⁺ content is preferably 0%.

La³⁺ is an ingredient that improves the stability of the glass, but is not an essential ingredient. If the content of La³⁺ is greater than 6%, the glass stability is rather decreased, and it is difficult to obtain a high-quality optical glass. The more preferred content of La³⁺ is 0 to 3%.

Li⁺, Na⁺, and K⁺ are ingredients that increase the stability of the glass and lower the glass transition temperature, but are not essential ingredients. If the contents of Li⁺, Na⁺, and K⁺ are respectively greater than 5%, the glass stability is rather decreased, and it is difficult to obtain a high-quality optical glass. The more preferred contents of Li⁺, Na⁺, and K⁺ are 0 to 3%, respectively.

Insofar as the characteristics of the glass of the present invention are not impaired, other ingredients may be added to the optical glass of the present invention as necessary.

Hereinafter, the performance of the optical glass of the present invention will be described.

Performance Testing Methods

In the present invention, the refractive index (nd) is an annealing value of (−2° C./h) to (−6° C./h), and the refractive index and the Abbe number (vd) are measured in accordance with “GB/T 7962.1-1987 Test methods of colourless optical glass—Refractive index and coefficient of dispersion.”

The transition temperature (Tg) is measured in accordance with “GB/T 7962.16-1987 Colourless optical glass test methods—Linear thermal expansion coefficient, transformation temperature and yield point temperature,” i.e., a test sample is tested within a certain temperature range, when the temperature rises by 1° C., the straight lines of the low-temperature region and the high-temperature region on the expansion curve of the measured sample are extended to intersect, and the temperature corresponding to the intersection point is the transition temperature.

The performances of acid and alkali resistance are measured according to the “GB/T 17129-1997 Colourless optical glass test methods of chemical stability—Powder,” and represented by the percentage of leaching of the sample in the acidic solution and in the alkaline solution. According to the leaching value, the performances of acid and alkali resistance of the material are categorized into five levels, respectively, of which level 1 is perfectly good, level 2 is very good, level 3 is good, level 4 is poor, and level 5 is very poor.

The testing results show that the oxyfluoride glass of the present invention has optical properties of a low refractive index and an ultra-low dispersion. Its refractive index is 1.41 to 1.44. Its Abbe number is 99 to 102, preferably 101 to 102. At the same time, the glass has a transition temperature less than 460° C. and is suitable for preparation of aspheric optical lenses by precision press molding. Furthermore, the glass has excellent acid and alkali resistance. According to the above powder method, the leaching amount of the glass in the alkaline solution is 0.08 to 0.20%, which corresponds to level 2 to 3; and the leaching amount of the glass in the acidic solution is 0.23 to 0.43%, which corresponds to level 2 to 3.

The present invention further provides an optical element made of the above-described low dispersion oxyfluoride glass. The manufacturing method thereof is not limited and may be a method known to those skilled in the art. The optical elements include, but are not limited to, spherical, aspherical, and planar lenses, prisms, gratings, and the like. The optical element also has optical properties of a low refractive index and an ultra-low dispersion, and can be applied to digital cameras, digital video cameras, camera phones and other devices.

Hereinafter, the present invention will be better described with the following representative examples. It should be understood that the following examples are only used to explain this invention and do not limit the scope of this invention. Any non-essential improvements and modifications made by a person skilled in the art based on this invention are all protected under the scope of this invention. The specific parameters below such as time, and temperature are only exemplary within an appropriate range, and a person skilled in the art can choose proper values within an appropriate range according to the description of this article, and are not restricted to the specific values cited below.

In the following Examples and Comparative Examples, the conventional glass melting method was employed, and the glass melting temperature, the discharging temperature, and the protection atmosphere for melting were adjusted accordingly, due to the difference in composition among the respective Examples and Comparative Examples, while the other processes are the same.

According to the ingredients listed in the Examples and Comparative Examples, high-purity raw materials were weighted to prepare 2000 g of powders, uniformly mixed, put into a platinum crucible, heated in an electric furnace and melted at 1150° C. to 900° C. for 3 hours. The glass melt was fed with a gas with stirring, and then cooled to 820° C.˜750° C., kept thereat for two hours, poured into a mold, and annealed to give an optical glass blank. In Tables 1 and 2, Tm indicates the glass melting temperature and Tl indicates the pouring temperature. “White spots of stone” refers to observing whether there are white spots of stones in the glass under sunlight.

The optical glass prepared in the above examples has excellent optical quality, a low refractive index, an excellent dispersion performance, and an Abbe number of 99 to 102. Meanwhile, the glass has an excellent acid and alkali resistance and a low glass transition temperature, and is suitable for preparation of optical elements such as high-performance spherical, aspherical, and planar lenses, prisms, and gratings by precision press molding, secondary hot pressing, and cold working methods. However, the optical glass prepared in the above comparative examples is poor in optical quality, has many stones, or has poor acid and alkali resistance, and thus an optical blank for commercial use can hardly be obtained, or the dispersion is high, and the Abbe number is lower than 99.

1. A low dispersion oxyfluoride glass comprising:
in terms of cationic molar percentage: Al³⁺: 18 to 50, Y³⁺: 10 to 18, Mg²⁺: 5 to 12, Ca²⁺: 15 to 25, Sr²⁺: 5 to 15, Ba²⁺: 5 to 12, P⁵⁺: 0 to 0.1, La³⁺: 0 to 6, Li⁺: 0 to 5, Na⁺: 0 to 5, and K⁺: 0 to 5; and
in terms of anionic molar percentage: F⁻: 97 to 99.98, O²⁻: 0.02 to 3, and Cl⁻: 0 to 1.

2. The low dispersion oxyfluoride glass of claim 1, wherein the glass comprises:
in terms of cationic molar percentage: Al³⁺: 30 to 40, Y³⁺: 12 to 16, Mg²⁺: 7 to 11, Ca²⁺: 18 to 22, Sr²⁺: 8 to 12, Ba²⁺: 8 to 10, P⁵⁺: 0 to 0.1, La³⁺: 0 to 3, Li⁺: 0 to 3, Na⁺: 0 to 3, and K⁺: 0 to 3; and
in terms of anionic molar percentage: F⁻: 99 to 99.5, O²⁻: 0.05 to 1, and Cl⁻: 0 to 0.5.

3. The low dispersion oxyfluoride glass of claim 1, wherein the glass does not comprise P⁵⁺.

4. The low dispersion oxyfluoride glass of claim 1, wherein the oxyfluoride glass has an Abbe number of 99 to 102.

5. The low dispersion oxyfluoride glass of claim 1, wherein the oxyfluoride glass has a refractive index of 1.41 to 1.44.

6. The low dispersion oxyfluoride glass of claim 1, wherein the oxyfluoride glass has a transition temperature of less than 460° C.

7. The low dispersion oxyfluoride glass of claim 1, wherein the F⁻ is introduced by employing fluorides of the cations in the composition as starting materials, and the Cl⁻ is introduced by employing chlorides of the cations in the composition as starting materials.

8. The low dispersion oxyfluoride glass of claim 1, wherein the O²⁻ is introduced by employing oxides of the cations in the composition as starting materials.

9. The low dispersion oxyfluoride glass of claim 1, wherein the O²⁻ is introduced by the following process: during the high-temperature reaction melting of the glass melt, the glass melt is protected by an atmosphere containing oxygen element to introduce O²⁻, or an atmosphere containing oxygen element is fed into the glass melt, so that the atmosphere containing oxygen element reacts with the fluoride ingredient to introduce O²⁻.

10. An optical element made of the low-dispersion oxyfluoride glass of claim 1.

11. The low dispersion oxyfluoride glass of claim 9, wherein the atmosphere containing oxygen element is at least one of air, oxygen, and water vapor.
